(19) United States
(12) Patent Application Publication
(10) Pub. No.: US 2002/0179373 A1
(43) Pub. Date: Dec. 5, 2002

(54) Lubrication system for shielded cables

(76) Inventors: Gabriel Luis Font, Clearwater, FL (US); Joseph Arthur Vinciguerra, Clearwater, FL (US)

Correspondence Address: Gabriel Luis Font, 1016 Hollywood Ave, Clearwater, FL, 33759, US

(21) Appl. No.: 09/867,690

(22) Filed: May 29, 2001

(51) Int. Cl. F16N 7/16

(52) U.S. Cl. 184/15.1

(57) ABSTRACT

Lubrication System for Shielded Cable was developed as a method to penetrate and lubricate cables of various sizes at any point on the cable. The system was developed using a split block that straddles the cable, and is held together with fasteners. On one side of the block, there is a small hole centrally located. A hole is to be drilled through that small hole to penetrate one side of the shielded cable to allow passage of the lubricant. Over the small hole and toward the outside surface of the part, a grease or oil fitting is mounted to allow the lubricant to be forced into the cable. Lubrication of shielded cables, as described here, has not been previously accomplished without this system.

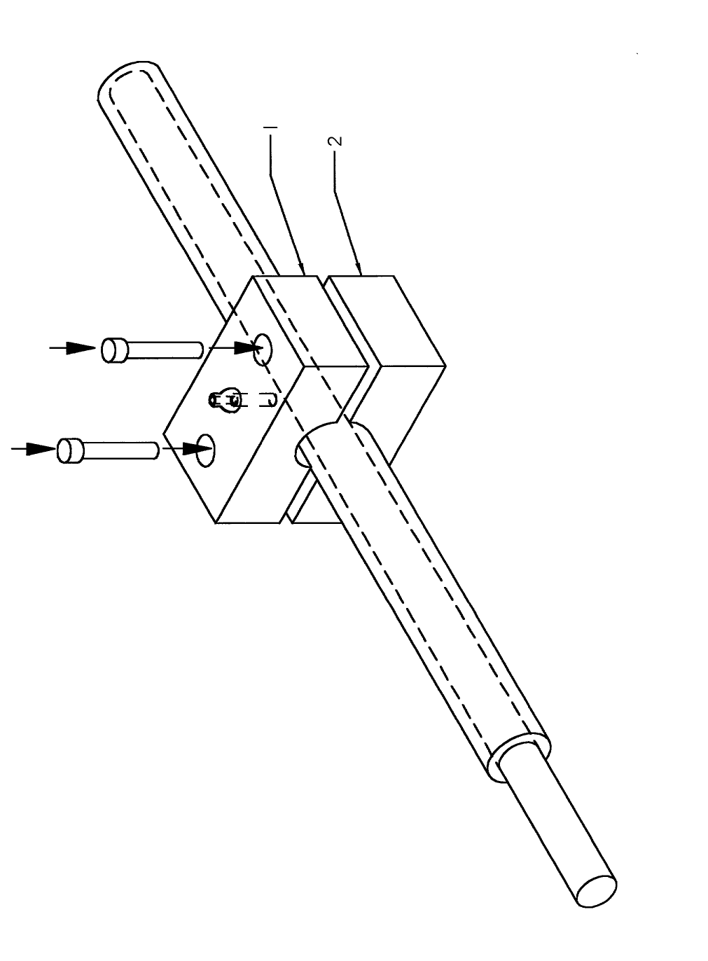

This is a device that will allow the user to lubricate sealed marine, farm, and industrial shielded cables without disassembly of the cable. The lubrication device is clamped onto each side of the cable.

The top (or part #1) is a rectangular block constructed with two holes used for clamping part #1 to part #2 and one threaded hole for insertion of a grease or oil nipple. This hole will be centrally located through a concave feature that runs the length of the part and is perpendicular to the mounting holes and the lubrication hole. This concave feature will capture the cable on the side that is to be penetrated to allow the injection of the lubricant.

The bottom portion (or part #2) is a rectangular block with like proportions to part #1. Part #2 is constructed with two threaded mounting holes and a concave feature that runs the entire length of the part and mirrors part #1's concave feature.

When the device is installed, parts #1 and #2 will capture the shielded cable on each side within the concave features and the features will be fastened to each other by the fastening screws. In order to allow the lubricant to enter the cable, a small hole must be drilled into the shielded cable. This hole penetrates only one side of the cable. This drilling is done through the hole in the grease or oil nipple and needs to only “break through” one side.

1. We claim the unique benefit of this lubrication system is the ability to inject the lubricant into the side of the cable at any available point on the cable. This is accomplished by simply mounting the system to the cable, and through a small hole in the system penetrating the cable with a small drill bit to allow introduction of the lubricant.
This system is self-sealing and after the cable is penetrated the lubricant can be delivered through a fitting and is then forced into the cable itself.
This system allows the lubrication of the entire cable without dismantling any part of the existing cable system. The lubrication system forces the lubricant inside the cable and toward each end of the cable. With this lubrication system it is possible to fill the entire cable with lubricant.
